(19) United States
(12) Patent Application Publication
(10) Pub. No.: US 2015/0129780 A1
(43) Pub. Date: May 14, 2015

(54) MULTILAYER STRUCTURE

(71) Applicant: ARJOWIGGINS SECURITY, Boulogne-Billancourt (FR)

(72) Inventor: Thibault Le Loarer, Pommier De Beaurepaire (FR)

(21) Appl. No.: 14/358,614

(22) PCT Filed: Nov. 13, 2012
(86) PCT No.: PCT/IB2012/056390

§ 371 Date: May 15, 2014

(30) Foreign Application Priority Data
Nov. 14, 2011 (FR) 11 60344

(51) Int. Cl. B42D 25/333; G01N 21/25; G01N 21/64

(52) U.S. Cl. CPC B42D 25/333; G01N 21/64; G01N 21/251; G01N 2201/061; B42D 2033/04; B42D 2033/32
USPC 250/459.1; 283/113; 250/226

(57) ABSTRACT

A multilayer structure contains a first security element, in particular a watermark or pseudo-watermark. A diffusing structure having a diffusing region that at least partially covers the first security element. A first luminescent layer at least partially covers the first security element and is capable of emitting a visible light of a first color when subjected to a predefined excitation radiation. The first luminescent layer extends between the first security element and the diffusing structure or the diffusing structure extends between the first security element and the first luminescent layer. In one variation, the first security element is observable in light transmitted through the multilayer structure when the structure is subjected to a predefined excitation radiation and/or in white light, only from the face of the structure situated on the same side as the first security element.

### CROSS-REFERENCE TO RELATED APPLICATIONS

This nonprovisional application is a national stage application of and claims priority to PCT Patent Application No. PCT/IB2012/056390, entitled “MULTILAYER STRUCTURE,” filed Nov. 13, 2012, which claims priority to French Patent Application No. FR 11/60,344 having the same title and a filing date of Nov. 14, 2011, both of which are herein incorporated by reference.

### BACKGROUND OF THE INVENTION

1. Field of the Invention

The present invention relates to the field of security documents or other security articles.

It relates more particularly, but not exclusively, to multilayer structures able to constitute or to be integrated into a security document.

2. Brief Description of the Related Art

In order to make a document secure, a known solution is to use security elements known as “first level elements” which comprise security elements detectable by the naked eye in visible light and without using any particular apparatus and/or security elements known as “second level elements” which are detectable only with the aid of a relatively simple apparatus such as a lamp emitting in the ultraviolet or the infrared. It may sometimes furthermore turn out to be desirable to use security elements known as “third level elements”, capable of generating a specific signal when subjected to an optoelectronic, electric, magnetic or electromagnetic excitation.

Multilayer structures are known from the publications EP 2 116 366 A1 or WO 2011/072818 A1.

Plastic cards with an RFID device, only comprising polymer layers, are known which have little or no authentication security features, notably visual, except perhaps for printed security features, embossed surface features or holograms applied by transfer, such as that marketed by the company Hologram Industries under the trademark DID.

It is relatively easy for a fraudster to procure blank plastic cards and to reproduce the printed features, customized features and visual security features present on an authentic plastic card.

More recently, metal reflecting elements on which a micropattern is engraved and which are incorporated into a layer of polycarbonate have been marketed by the company BAYER under the brand PROTEXXION. The elements are visually identifiable only with the aid of a microscope, and there is no security feature provided by the structure of the card itself.

There exists a need for the inclusion of multilayer structures offering sufficient security guarantees and allowing, where desired, novel visual effects to be produced for the observer trying to authenticate the security document.

It is also known to use watermarks as security means in security documents which allow a document to be authenticated by observation in transmitted light. Watermarks allow a protection from copying by optical means such as photocopying, photography or digitization. Watermarks may also be used for decorative and prestige purposes, notably for printing-writing paper, for example for letterheads or artwork paper such as papers for water color.

The present invention also relates to security documents in the form of a booklet, for example such as a passport booklet, generally comprising a cover and one or more internal sheets, for example at least sixteen sheets in the case of a passport booklet.

In order to enable such documents to be made secure, notably against attempts to falsify them and/or produce counterfeit documents, those usually comprise at least one page of an internal sheet which comprises security data, for example personal data printed, engraved or etched, and potentially also a photograph relating to the carrier of the multi-sheet document. In order to further improve the security, this data may be covered with a holographic protection film. Furthermore, in order to enable the authentication of such a document and render a counterfeit attempt more difficult, the booklet may furthermore comprise one or more well-known security elements, such as a watermark or pseudo-watermark, an integrated microcircuit device, amongst others, where these security elements may notably be printed onto one or more pages of the internal sheets and/or integrated into the latter.

The international patent application WO 2007/034129 describes a document comprising a cover and an internal sheet having a page of secure data. The page of data notably comprises a layer on which appears visible personal data relating to the carrier of the document and another layer comprising an electronic device in which all or a part of this personal data is stored, the two layers being laminated between two other layers of plastic. Such a document has several drawbacks, notably in that it is virtually impossible to be able to customize the document after fabrication. Indeed, the presence of layers of plastic renders difficult the physical customization of the page of data in the booklet with printed visible data after the assembly of the booklet. Moreover, it also turns out to be difficult to digitally customize the document with a recording of all or part of the personal data in the chip simultaneously with the physical customization of the document by visible printing of this data.

The use of luminescent compounds, visible under UV or IR illumination, is furthermore known in security documents. A combination of luminescent layers is even included in the publication WO 2006/051231. For example, a transparent medium is coated on its opposing faces with metal layers that have been partially de-metallized, themselves covered by fluorescent layers emitting different colors when excited, which allows a third color to be generated in the regions where the fluorescent layers are superposed.

FR 2 948 218 discloses a combined image superposed onto a detection screen, situated on either side of a transparent or translucent substrate. The detection screen or the combined image may comprise optical, magnetic or metallization elements. Amongst many other possibilities, the detection screen and the combined image may each comprise a fluorescent region.

WO 2011/073944 discloses a multilayer structure comprising a luminescent layer and a watermark.

A need exists to further improve the protection of security and/or valuable documents against falsification.

### BRIEF SUMMARY OF THE INVENTION

The present invention is notably aimed at meeting the longstanding but heretofore unmet need for improving the protection of documents against falsification. One subject of the invention, according to a first of its aspects, is a multilayer structure comprising:
a first security element, notably a watermark or pseudo-watermark,
a diffusing structure (further referred to as interposed sub-structure in certain exemplary embodiments hereinafter, comprising a diffusing region being at least partially superposed onto the first security element,
a first luminescent layer capable of emitting, when it is subjected to a predefined type of exciting radiation, notably UV or IR, visible light of a first color (C1), the first luminescent layer extending at least partially between the first security element and said diffusing structure, notably its diffusing region, or the diffusing structure, notably its diffusing region, extending at least partially between the first security element and the first luminescent layer, the first luminescent layer being at least partially superposed onto the first security element.

The invention allows different effects to be obtained depending on the incidence side of the exciting light, and notably allows the security element to visually appear differently depending on whether the exciting light reaches the luminescent layer after having passed through the diffusing region or otherwise.

The fact that the first layer emits a light of a first color at a given location does not mean that the latter cannot emit with another color at another location, the composition of the first layer being able to vary from one location to another, notably when the first layer is formed by application of compounds with different formulations producing different colors in such a manner as to generate a polychromatic overall pattern.

The first security element is for example only observable in transmitted light, through the structure, when it is subjected to the predefined type of exciting radiation and/or observed in white light, and only from the face of the structure situated on the same side as this first security element.

In particular, in the case of a luminescent layer that fluoresces under UV or IR radiation and of a security element consisting of a watermark, the effect obtained may be that, on one side, the watermark is visible then invisible when the side of the UV or IR exciting radiation is changed, because the diffusing region attenuates the UV or IR exciting radiation by scattering it to such an extent that the luminescent layer no longer emits enough visible light to illuminate the watermark.

The first luminescent layer may comprise a mono- or polychromatic pattern; “polychromatic” is understood to mean that it is capable of emitting, when it is subjected to the predefined type of exciting radiation, notably UV or IR, visible light of several colors according to the regions of the pattern.

In the case of a watermark or pseudo-watermark as first security element, the pattern may reproduce the pattern of the watermark or pseudo-watermark.

The pattern may be located in register with respect to the first security element, notably watermark or pseudo-watermark, or disposed so as to be located in register with respect to a clear region of said watermark or pseudo-watermark.

Such a structure has the advantage of combining a security observable in visible light, notably a watermark, and a hidden image, invisible to the naked eye, notably a UV image. This type of structure is easily identifiable when the security element and the luminescent layer consist of similar patterns observable in white light and, respectively, in a predefined exciting light.

According to one exemplary embodiment, the pattern of the luminescent layer comprises a reduction or an enlargement of a pattern of the security element, and represents for example the same object, monument, famous person, vegetation or animal.

According to another exemplary embodiment, the two patterns are identical but placed in a symmetrical fashion.

The patterns of the security element and of the luminescent layer may be different. In particular, the patterns may be complementary, either in their visual effect or with respect to a design or an image. The pattern may, for example, be a watermark or pseudo-watermark representing a national emblem, a Marianne, and, as a hidden pattern belonging to the luminescent layer, another national emblem different from the first, for example a map of France or else a text.

The multilayer structure may comprise, aside from the first security element, which is preferably a watermark or pseudo-watermark:
a second security element, preferably a watermark or pseudo-watermark,
a second luminescent layer, with a different composition from the first, capable of emitting, when it is subjected to the predefined type of exciting radiation, visible light of a second color different from the first, the second luminescent layer being at least partially superposed onto the second security element.

Preferably, the diffusing structure is situated between the first and second luminescent layers, its diffusing region being preferably at least partially superposed with the luminescent layers and with the security elements. In one variant, the first and second luminescent layers are each superposed onto a diffusing region of the diffusing structure but are not superposed onto each other.

The diffusion of the light by the diffusing structure may enable an effect to be obtained known as “Dual watermark” which resides in the fact that, on each side of the multilayer structure, only the security element situated on this side with respect to the diffusing structure is essentially visible in transmitted light, under usual observation conditions.

Here, the diffusing structure may also provide an attenuation effect for the exciting radiation which produces the aforementioned additional effect, preventing the two luminescent layers from being excited at the same time. This effect is known as “Dual fluo”.

The diffusing region allows the incident exciting radiation to be scattered and, when the diffusing region is situated between the security element and the luminescent layer, avoids incident exciting radiation coming from the same side as the security element exciting the luminescent layer and, when the luminescent layer is situated between the diffusing region and the security element, avoids incident exciting radiation coming from the diffusing region side exciting the luminescent layer.

The invention allows attractive visual effects, if desired, to be obtained and the security to be improved by the construction of the multilayer structure.

The invention provides a multilayer structure incorporating security elements of level 1 and of level 2. This renders very difficult the counterfeiting of a security document comprising such a structure, for example a card, and renders its falsification virtually impossible.

The invention allows, in particular, securities of level 1 and 2 to be provided that are integrated into the structure of an identity card, a driver's license, a credit or debit card, a passport or a bank note.

The security is provided by the structure itself, and not by printed security features or patches, for example holographics.

The security system is very difficult to counterfeit since it requires technical industrial means, for example a cylinder paper mold machine for the watermarks when the security elements are watermarks.

The first and/or the second security element may be a watermark or pseudo-watermark or a video sequence.

The first security element may comprise a coded image which can only be visualized through a detection screen, the coded image comprising for example interlaced images producing, when observed through a detection screen, with a change in the direction of observation or a relative movement of the detection screen and the image, a video sequence. Examples of such security features are disclosed in the publications FR 2 940 179, FR 2 948 216, FR 2 948 217 and FR 2 948 218 by the applicant. The security element may furthermore comprise a metal deposition comprising de-metallized regions.

The first and/or the second security element may be visible either by reflection or by transmission, or by transmission and movement along one of the axes of the multilayer structure. The movement of the screen allows the image to be revealed and a video sequence to be created.

The fact that the luminescent layers are superposed in some exemplary embodiments of the invention may be advantageously exploited where it is desired to use one of the layers in order to contribute to blocking the exciting radiation incident on one face of the structure, and to prevent the other luminescent layer from being excited. Exciting both layers simultaneously by illuminating a single face of the structure is thus avoided and the security elements may be displayed with only one of the colors produced at a time by excitation of the luminescent layers.

In order to form the diffusing structure, and notably its diffusing region, a material non-opaque to the exciting radiation but diffusing the latter may be used. This allows the quantity of exciting radiation (IR or UV) that will completely pass through the sub-structure to be attenuated. In daylight, a conventional Dual watermark effect, as mentioned hereinabove, can be observed.

The luminescent layers are preferably transparent in daylight and pigments are preferably used that are invisible in daylight and visible under excitation.

There may be at least one opening in at least one of the luminescent layers, notably in the first luminescent layer, so as for example to have a checkerboard effect in fluorescence.

There may be at least one opening in at least one of the luminescent layers, notably in the first luminescent layer, and a diffusing structure that is luminescent with another color.

A colored diffusing structure may be envisioned, with a low color saturation, so as not to block the transmitted light and not to lose the Dual watermark effect; if the diffusing structure is colored, the two watermarks of the Dual watermark effect in daylight will be colored; this color may be combined with the color resulting from the excitation of the luminescent layers.

The first luminescent layer may be distinct from a layer carrying the first security element, notably a fibrous layer, the security element then preferably being a watermark. As a variant, the first luminescent layer may be at least partially, or even entirely, coincident with a layer carrying the security element, being for example a compound present within the bulk of a fibrous layer, the security element being for example a watermark formed within this fibrous layer.

A further subject of the invention is a method for authenticating a multilayer structure according to the invention, comprising the following steps:
observe the multilayer structure in transmission by illuminating from the side opposite to the first security element with the exciting radiation causing the luminescence of the first luminescent layer and a visible light, and by observing on the side of the first security element,
observe the structure in reflection by illuminating on the same side as the first security element with said exciting radiation and visible light and by observing on the side of the first security element,
generate information relating to the authenticity by comparing the aspects of the first security element under the various conditions of observation hereinabove.

According to another of its aspects, another subject of the invention is a security document incorporating a multilayer structure such as previously defined.

The security document may comprise a booklet. The security document may constitute an identity document, notably a passport, a means of payment, notably a bank note, a coupon, a check, a voucher or a credit card, a ticket for access to cultural or sports events, a certificate of authenticity, amongst others.

According to another of its aspects, another subject of the invention is a method for authenticating a document or a structure comprising the following steps:
by illuminating the structure with a light capable of exciting the luminescence of the first and second luminescent layers:
observation by reflection of at least one of the first and second security elements, notably watermarks or pseudo-watermarks,
observation under this illumination, by transmission, of at least one of the first and second security elements, notably watermarks or pseudo-watermarks,
information relating to the authentication being determined at least according to the comparison of the observations a) and b).

The passage between reflected light and transmitted light may be effected by turning the structure over or by changing the side for illuminating the structure. At least one change in color is then seen in the watermark being observed.

In particular, when the structure is turned over, the first and second watermarks with different colors are successively observed.

When the document comprises a multilayer structure comprising at least one phosphorescent layer, the method may comprise the following successive steps:
illuminate the phosphorescent layer of the structure with a light capable of exciting the phosphorescence of said layer and observe the first security element, notably a watermark or pseudo-watermark, with the color of luminescence of the phosphorescent layer,
stop the illumination and turn the structure over or vice versa, and observe a second security element, watermark or pseudo-watermark, with the color of luminescence of the phosphorescent layer by remanence of the phosphorescence.

When the document comprises a multilayer structure comprising two fluorescent layers, the method may comprise the following steps:
observe at least one of the security elements, watermark or pseudo-watermark, on one of the faces of the structure,
illuminate successively each of the faces of the structure with the predefined light for exciting the fluorescence of the first and second layers,
observe the change in color of illumination by luminescence of said security elements.

In another variant, with a multilayer structure such as previously defined comprising two fluorescent layers, the method comprises the following steps:
illuminate one of the faces of the structure with a light for exciting the fluorescence of the first and second luminescent layers,
turn the structure over and observe the change in color of the watermark or pseudo-watermark.

When the watermarks or pseudo-watermarks exhibit different patterns, the passage from one pattern to the other is also observed.

### BRIEF DESCRIPTION OF THE DRAWINGS

For a fuller understanding of the invention, reference should be made to the following detailed description, taken in connection with the accompanying drawings, in which:

FIG. 1 shows, as an exploded cross section, one example of a structure according to the invention,

FIG. 2 shows, in perspective, the front face of the structure in FIG. 1,

FIG. 3 shows, in perspective, the back face of the structure in FIG. 1,

FIG. 4 shows, in cross section, another example of a structure according to the invention

FIG. 5 shows, as a face-on view, the front face of the structure in FIG. 4,

FIG. 6 shows, as a face-on view, the back face of the structure in FIG. 4,

FIG. 7 shows, in cross section, one example of a document according to the invention,

FIGS. 8 and 9 show, in perspective, various views of the booklet document in FIG. 7,

FIG. 10 shows, in cross section, the detail X in FIG. 8,

FIG. 11 shows one example of a multilayer structure according to another exemplary embodiment of the invention,

FIGS. 12A to 12D illustrate the observation of the security element in FIG. 11 according to various conditions of illumination,

FIG. 13 is an analogous view to FIG. 11 of one variant embodiment,

FIGS. 14A to 14D illustrate the observation of the security element in FIG. 13 according to various conditions of illumination,

FIGS. 15A and 15B illustrate the observation of one variant embodiment of a security document according to the invention under various conditions of illumination, and

FIG. 16 shows a detail of one example of a multilayer structure according to one exemplary embodiment of the invention.

In the figures, in particular the cross sections, the real proportions of the component elements have not always been adhered to, for the sake of clarity.

### DETAILED DESCRIPTION OF THE PREFERRED EMBODIMENT

The structure 10 illustrated in FIG. 1 comprises two fibrous layers 45 and 46 between which a diffusing structure is disposed in the form of an interposed sub-structure 11 which is, in this example, entirely translucent, such that the diffusing region extends over the whole of the diffusing structure. The fibrous layers 45 and 46 comprise security elements of level 1 in the form of watermarks 55 and 56.

The structure 10 comprises a first luminescent layer 38 placed between the interposed sub-structure 11 and the fibrous layer 45, and a second luminescent layer 39 placed between the interposed sub-structure 11 and the fibrous layer 46.

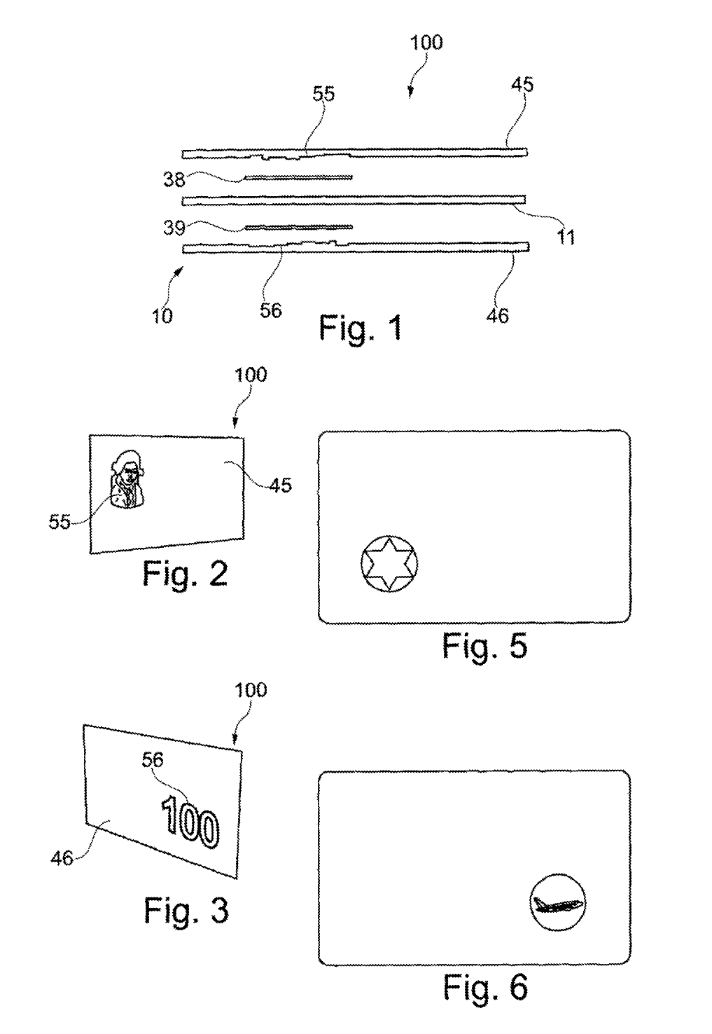

The structure 10 illustrated in FIG. 1 constitutes a security document 100 such as a bank note. FIG. 2 shows the front of the security document 100 in FIG. 1, the watermark 55 reproducing an image, for example the portrait of a famous person. As illustrated in FIG. 3, the watermark 56, visible on the back of the security document 100 in FIG. 1, reproduces a text, here the nominal value of the bank note.

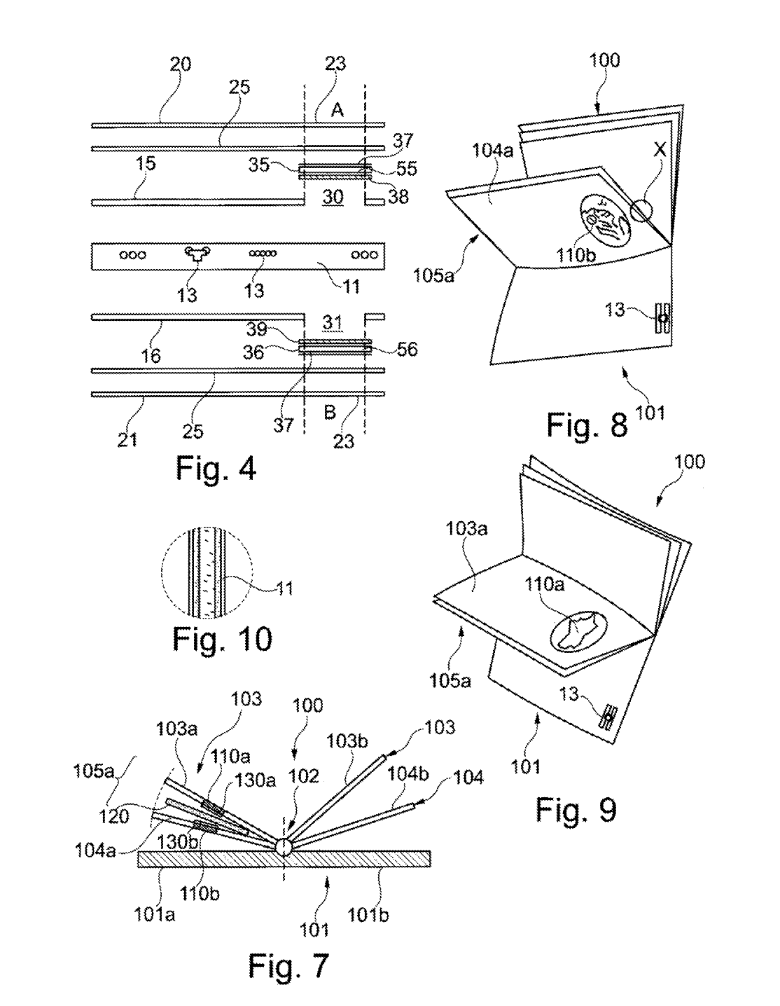

In the example in FIG. 4, the structure 10 according to the invention comprises a paper patch 35 having a security element formed by a watermark or pseudo-watermark 55, for example with a “star” pattern, and a second paper patch 36 having a security element formed by a watermark or pseudo-watermark 56 with a different pattern, for example an “airplane” pattern.

The paper patch 35 is coated with a fluorescent layer 38, with a green color under UV light on the face turned toward the interposed sub-structure 11, and with a layer of adhesive 37 on the other face.

The paper patch 36 is also coated with a fluorescent layer 39, with a red color under UV light, on the face turned toward the sub-structure 11, and with a layer of adhesive 37 on the other face.

As illustrated, the fluorescent layers 38 and 39 are preferably situated on the face of the patches 35 and 36 turned toward the interposed sub-structure 11, in other words under the watermarks 55 and 56 when looking at the structure 10, and this allows both the color of the fluorescence and the watermark which is revealed by the light emitted by luminescence to be observed.

The structure 10 is for example a flat card in the ID-1 format of substantially constant thickness, for example with a thickness equal to 760 μm+/−80 μm conforming to the standard ISO-10373.

The structure 10 according to the invention may comprise at least one apertured layer 15 disposed on one side of the interposed sub-structure 11, or better two apertured layers 15 and 16 respectively disposed on either side of the interposed sub-structure 11, as illustrated in FIG. 4.

Additional layers may be provided between the apertured layers 15 and 16 and the external faces 20 and 21 of the structure 10, in order for example to carry printed features or laser markings.

In the example illustrated, there are two additional layers on either side of the interposed sub-structure 11, consisting of a transparent external layer 23, preferably of polycarbonate, with a thickness in the range between 25 and 75 μm, for example of around 50 μm in thickness, and an underlying layer 25 markable by laser, for example also of polycarbonate, with a thickness in the range between 25 and 150 μm, for example around 50 μm or 100 μm.

In the example illustrated, the additional layers 23 and 25 are the same on the front or back side of the structure 10, but the additional layers 23 and 25 could be different, for example with regard to their nature, their thickness and/or their aspect.

The openings 30 and 31 in the apertured layers 15 and 16 define respective observation areas A and B on either side of the structure 10.

The paper patches 35 and 36 are disposed in openings 30 of the apertured layers 15 and 16 and are respectively observable in the areas A and B.

The openings 30 and 31 may have the same shape in the apertured layers 15 and 16, for example they could be circular with a diameter d. The openings may have other shapes, for example polygonal or more complex.

Each patch 35 or 36 may have an extent slightly greater than that of the corresponding opening, so as to cover the edge of this opening. In the example where the contour of the opening is circular with a diameter d, the patch may have a diameter D >d. The difference between D and d is for example in the range between 0.5 and 3 mm.

The layers 15 and 16 are preferably non-transparent, being for example opaque of white polycarbonate.

The interposed sub-structure 11 may be formed with a transparent thermoplastic material, preferably polycarbonate, and the thickness of the interposed sub-structure 11 is for example in the range between 300 and 400 μm, for example around 350 μm. The interposed sub-structure 11 is translucent and diffusing, such that for example a pattern present on the patch 35 is only visible from the side of the face 23, and conversely a pattern visible on the patch 36 is only visible from the side of the face 21, owing to the scattering of the light through the interposed sub-structure 11.

The light-scattering nature of the interposed sub-structure 11, in its diffusing region, may result from its index of refraction, from its composition, from its thickness and/or also from its surface irregularities.

According to one particular case, the surface irregularities of the interposed sub-structure 11 may be obtained by embossing or graining of this surface.

According to another particular case, the interposed sub-structure 11 comprises cavities, for example bubbles, endowing it with a light-scattering nature.

According to another particular case, the interposed sub-structure comprises a diffusing charge chosen in particular from amongst mineral pigments, in particular kaolin or titanium dioxide, and organic pigments, in particular polystyrene or polyurethane beads.

It is advantageous for the diffusing region of the interposed sub-structure 11 to be translucent in the presence of patches each carrying a watermark or pseudo-watermark, as previously mentioned.

The structure 10 according to the invention illustrated in FIG. 4 furthermore comprises, within the interposed sub-structure 11, an electronic device 13, for example an identification device with a contactless integrated microcircuit as previously detailed.

In the example illustrated, the interposed sub-structure 11 (also referred to as inlay or core) incorporates an antenna, preferably wired, which may be connected to the device 13 or electromagnetically coupled to the latter.

The interposed sub-structure 11 may be a monolayer or a multilayer, being a mono- or multi-material. Preferably, the interposed sub-structure 11 has a constant thickness.

In the example illustrated, the structure 10 comprises a contactless RFID device entirely buried within the thickness of the interposed sub-structure 11 which is not flush with the interface of the interposed sub-structure 11 with the adjacent layers of the structure.

The structure 10 allows a watermark in the form of a star as illustrated in FIG. 5 to be observed on its front face, whereas the back face, illustrated in FIG. 6, has an airplane watermark.

FIG. 7 shows a security document 100 according to the invention comprising a cover 101 defining two sheets 101a and 101b connected by a folding line 102.

In this example, the document 100 comprises two internal sheets 103 and 104 linked together at the folding line 102.

Each internal sheet 103 and 104 comprises an internal page 103a and 104a, each carrying a watermark or pseudo-watermark 110a and 110b covered by a luminescent layer 130a and 130b, the two pages 103a and 104a appearing on the same side of the folding line 102. In this way, the watermarks or pseudo-watermarks 110a and 110b are at least partially superposed. Thus, the watermarks or pseudo-watermarks 110a and 110b are carried by two separate sheets 103 and 104 of the document 100.

The document 100 comprises an interposed sub-structure 120 situated between the internal pages 103a and 104a of the internal sheets 103 and 104 which may, at least in part, be superposed on the watermarks or pseudo-watermarks 110a and 110b.

The page 103a and/or the page 104a are optionally covered by an external layer not shown, notably by a thermoplastic film.

In FIG. 7, the interposed sub-structure 120 has a width that is less than the width of the pages 103a and 104a in such a manner that the document 100 has areas on either side of the interposed sub-structure 120 that may potentially allow the fibrous layers constituted by the internal pages 103a and 104a to be assembled together.

In one variant not illustrated, the interposed sub-structure 120 has a width that is greater than the widths of the internal pages 103a and 104a, and is positioned between the internal pages 103a and 104a in such a manner that the external end of the sub-structure 120 is exactly superposed on the external ends of the internal pages 103a and 104a, and that the internal end of the interposed sub-structure 120, in other words the end located at the folding line 102, is fixed to the cover 101 at the folding line 102, for example by gluing or stitching.

In another variant, the sub-structure is, in contrast, also fixed by its internal end to the cover 101; the external end of the sub-structure 120 is not superposed on the external ends of the internal pages 103a and 104a.

The document 100 furthermore comprises an electronic device 13 as illustrated in FIGS. 8 and 9, for example integrated into the cover.

FIG. 8 shows the front side of the page 104a on which it is noted that the watermark 110b carried by the fibrous layer forming the page 104a is only observed in transmitted light.

FIG. 9 shows the back side of the page 103a on which it is noted that only the watermark 110b carried by the fibrous layer forming the page 104a can be observed in transmitted light.

In particular, the watermarks or pseudo-watermarks may be complementary. They may be complementary in their visual effect or with respect to a design or an image. For example, in the case of a structure according to the invention, as first watermark or pseudo-watermark, on one side a national emblem may be applied, a Marianne in the example illustrated, and as second watermark or pseudo-watermark on the other side, another national emblem, different from the first, may be applied, a map of France as illustrated in FIG. 9, or alternatively a text.

According to another exemplary embodiment not illustrated, the two watermarks or pseudo-watermarks are identical but placed symmetrically. In the case of an authentication, it may then be advantageous to verify this identity between the watermarks or pseudo-watermarks on the two faces of the structure (for example a famous person always looking on the same side).

In FIG. 7, for the sake of clarity, the pages 103a and 104a, the luminescent layers 130a and 130b and the interposed sub-structure 120 are shown separately, whereas in this embodiment, the pages 103a and 104a are sealed together in order to form a single sheet 105a, as illustrated in FIGS. 8 and 9.

The fibrous layers forming the pages 103a and 104a may be sealed at the interposed sub-structure 120 by means of adhesive or without adhesive by fusion or soldering.

In one exemplary embodiment, the interposed sub-structure 120 has a polymer layer on its external faces allowing its direct hot sealing under pressure onto the fibrous layers.

In another embodiment, on its external faces, the interposed sub-structure may have a polymer layer coated with an adhesive allowing its direct cold or hot sealing, with or without pressure, onto the fibrous layers. The polymer layer is for example made of PET coated with EVA.

In another embodiment, the two fibrous layers 103a and 104a have intrinsically on their internal surface facing the interposed sub-structure, a surfacing allowing their direct sealing with heat and under pressure onto the interposed sub-structure, the fibrous layers comprising for example a substrate made of paper coated with a latex thermo-sealing substance.

In another embodiment, on their internal surface facing the interposed structure, the two fibrous layers have an adhesive layer allowing their direct cold or hot sealing, with or without pressure, onto the interposed structure; these adhesive layers may be liquid adhesives previously spread while cold or hot onto the internal faces of the fibrous layers.

In another exemplary embodiment, layers of adhesive, which are themselves optically non-opaque and diffusing, are used to assemble the external fibrous layers and the interposed structure, for example films that are sensitive to pressure or thermoplastics. Since the layers of adhesive used between the fibrous layer 45 and the interposed sub-structure 120 and between the fibrous layer 46 and the interposed sub-structure 11 may be of different nature, the layers of adhesive used in the invention are for example layers of PSA (pressure sensitive adhesive) notably polyurethane or vinyl adhesive.

### Example 1

### Contactless Identity Card with Double Watermark Security

The structure corresponds to that illustrated in FIGS. 4 to 6.

The diffusing structure which is here an interposed sub-structure 11 and the layers 23 and 25 are made of translucent polycarbonate (PC) and the layers 15 and 16 of white polycarbonate, for example of thickness 100 μm. The interposed sub-structure 11 is around 350 μm in thickness and the layers 23 and 25 are 50 μm thick. UV rays pass through the translucent layers PC but they are at least partly scattered. The UV does not pass through the layers of white PC which are opaque.

The patches 35 and 36 made of paper have watermarks and are fabricated on a cylinder paper mold machine. The “star” watermark of the patch 35 is obtained with a conventional electrotype, known as galvano, and the “airplane” watermark of the patch 36 is obtained by the screened-image watermark technology of the applicant, described in the patent application US 2001/0018113.

The final card has a thickness of around 760 μm+/−80 μm, thus complying with the standard ISO10373. The card is equipped with a contactless system of communications complying with this same standard ISO 10373.

The fabrication of the card comprises the following steps:
fabrication of the papers with watermarks intended to form the “star” 35 and “airplane” 36 patches,
deposition of the fluorescent layer 38 with a green color under UV light on the paper with “star” watermark by roto-printing and of the fluorescent layer 39 with a red color on the “airplane” paper; the color is obtained under UV light and is invisible in daylight,
deposition of the layer of adhesive 37, for example a polyurethane or a vinyl compound, in the areas of the watermarks of the papers,
perforation at a diameter d of the two layers of white polycarbonate (PC) 15 and 16,
cutting out of the watermarked areas at a diameter D in order to form the patches 35 and 36; D is preferably slightly greater than d, for example of the order of 1 to 2 mm, so as to enable a perfect covering of the translucent region,
assembly of the patches 35 and 36 by means of the layer of adhesive 37 by hot pressing to the corresponding layer of polycarbonate (PC) 25, in such a manner that the patches 35 and 36 are disposed in front of the perforations in the layers of white polycarbonate 15 and 16, and in such a manner that the patches 35 and 36 and the corresponding layer 25 are rigidly fixed together so as to facilitate the later steps for pre-assembly and lamination,
pre-assembly of the various component layers of the card, namely white PC, translucent PC with patches previously deposited by hot compression, interposed sub-structure,
formation by ultrasound of fixing points, or by application of a hot iron, in order to maintain the layers stacked prior to lamination, for example on an SSH machine marketed by the company Muehlbauer.
hot lamination on a lamination press at a temperature of around 180° C. for around 20 min, the down-stroke press being for example that marketed by the companies Lauffer or Burkle,
cutting out of the cards in the ID 1 format,
graphic customization of the card, by a step for laser marking of the layer 25.

The layers of white PC 15 and 16 and/or the layers 23 and 25 may use offset printing and/or serigraphy with a printed security feature, for example microtext, UV ink or marker.

The customization is carried out from card to card preferably by laser etching, for example on a Datacard machine, on the laser-markable layer 25. Alternatively, the customization may be carried out by inkjet.

In one variant, at least one of the papers with watermark intended to form the patches comprises a hidden image only observable under the exciting radiation. During the fabrication of the paper, a mono- or polychromatic UV pattern reproducing the watermark design is deposited, in particular in the location of the watermark, by printing of one or more fluorescent layers with different colors under UV light on the paper with watermark, the color or colors being notably obtained only under UV light and invisible in daylight. After deposition of the layer of adhesive, the watermarked areas are cut out to a diameter D in order to form the patches. The dimensions of the watermark design and the diameter D are preferably chosen and the cut out effected so that each patch comprises only one watermark design and/or only one UV pattern.

When the card in the example 1 is illuminated by an ultraviolet source on the back side, the watermark observed on the front side is a red star whereas the watermark observed on the back side is a red airplane watermark. On the other hand, if the intermediate fluorescent layer is excited by an ultraviolet source emitting from the front side of the card, the watermarks observed will be respectively a green star on the front side and a green airplane on the back side.

An interesting effect is obtained by observing only one side and by alternatively illuminating the backside and the front side; the corresponding watermark is seen to change color. For example, if the front side is observed and the front side and the backside are alternatively illuminated, the star-shaped watermark is seen to change color.

As previously indicated, when the structure 10 comprises a watermark carried by at least one of the paper patches, it is advantageous for the latter to be superposed, at least partially, onto a translucent region of the rest of the structure, in such a manner that the watermark is observable in transmitted light through the structure only from the face of the structure adjacent to the paper patch in question. When the structure comprises two paper patches each comprising a watermark or pseudo-watermark, the latter may be observable in transmitted light through the structure, at its level, only from the face of the structure adjacent to the patch in question. Thus, the observations of the watermarks or pseudo-watermarks are made separately from the different respective faces of the structure, and the “Dual fluo” effect and the “Dual watermark” effect are simultaneously obtained.

### Example 2

### Passport

The document corresponds to that illustrated in FIGS. 7 to 10.

A passport comprises a booklet obtained by the stitching together of double pages inside of a cover. A double page is understood to mean a sheet folded in two which is stitched to the other sheets by means of a sewing thread.

Two double sheets 103 and 104 respectively comprising a first fibrous layer 103a with a first watermark 110a and a second fibrous layer 104a with a second watermark 110b are assembled with an interposed translucent and diffusing sub-structure 120.

A printed feature which is visible under UV or IR light is formed by flexography on the double pages of the booklet at the same time as the other usual security features printed on the VISA pages, for example by offset printing or intaglio printing.

The fluorescent layer 130a emits for example a blue light under UV and the layer 130b a red light.

When the front side of the page 105a is illuminated under UV and the front side of this page is observed in reflection, the map of France can be seen under blue fluorescence, and if it is observed from the back side in transmitted light, the Marianne is seen under blue fluorescence. If the back side of the page 105a is observed in reflection under UV, the Marianne is seen under red fluorescence.

### Example 3

### Multilayer Bank Note

This example corresponds to the embodiment illustrated in FIGS. 1 to 3.

The bank note comprises a first layer 45 of fibrous materials, of the order of 50 μm in thickness, based mainly on cotton, fabricated on a cylinder paper mold machine. This first layer 45 comprises a “Beethoven” watermark 55, obtained by the screened-image watermark technique and a first printed feature, extending at least partially into the area of the watermark 55, with a luminescent dye invisible in daylight and of green color under UV light.

The bank note comprises a second layer of fibrous materials 46 separated from the layer 45 by an interposed translucent and diffusing sub-structure 11 of 30 μm in thickness. The interposed sub-structure comprises a polymer with cavitations, for example bubbles or a light-collecting film, for example of the “waveguide” type, for example a luminescent film based on polycarbonate marketed by the company BAYER under the trademark LISA®, and comprises on either side of its faces an adhesive that is activatable by heat and irreversible.

The thickness of the fibrous layer 56 is of the order of 50 μm. The layer 56, fabricated on a cylinder paper mold machine, is based mainly on cotton. It comprises a “100” watermark obtained by using a “galvano electrotype” and a second printed feature 39 with a luminescent dye that is invisible in daylight and of yellow color under UV light, the printed feature extending, at least partially, into the area of the watermark 56. The watermarks 55 and 56 are superposed.

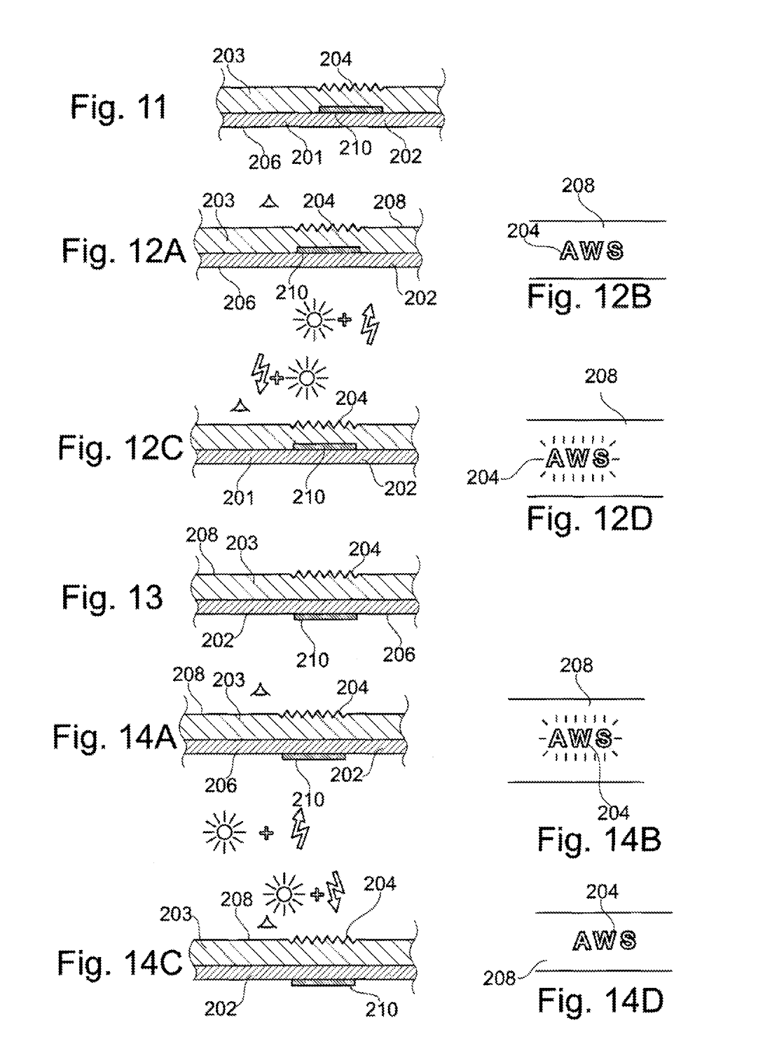

FIG. 11 shows a multilayer structure which may form a document or may belong to a document. The structure comprises at least the layers illustrated, namely a diffusing structure 201 having at least one diffusing region 202, and for example entirely diffusing over its whole extent. The structure 201 may be identical to the structure 11 described previously, and may form an interposed sub-structure.

The multilayer structure also comprises a layer 203, carrying the security element 204; the layer 203 is for example a layer of paper and the security element 204 a watermark.

A luminescent layer 210 is disposed between the structure 201 and the security element 204, being for example deposited, notably by printing, on the structure 201 or on the layer 203.

The layer 203 is for example fixed by gluing or lamination onto the structure 201.

The luminescent layer 210 extends, at least partially, between the diffusing region 202 and the security element 204.

When the multilayer structure in FIG. 11 is illuminated on the side of the face 206 opposite to the security element 204, as illustrated in FIG. 12A, by a light comprising visible light (schematically represented by a sun) and an exciting light (schematically represented by a lightning bolt), the visible light diffuses through the structure 210 and renders the security element visible from the side of the opposite face 208, as illustrated in FIG. 12B.

The exciting light is scattered by the structure 201 and its intensity is sufficiently low after passing through the region 202 such that the luminescent layer is not excited or the excitation is sufficiently weak for the light emitted by luminescence not to substantially change the aspect of the security element with respect to a situation where the light from the side of the face 206 would only comprise visible light.

If the multilayer structure is observed in reflection, as illustrated in FIG. 12C, by a light that is both visible and exciting, the latter is not scattered by the structure 201 and can excite the luminescent layer 210 which then emits visible light. The security element 204 changes appearance, owing to its illumination by the light emitted by luminescence by the luminescent layer 210, as illustrated in FIG. 12D.

The multilayer structure illustrated in FIG. 13 differs from that described with reference to FIG. 12 by the location of the luminescent layer 210, on the face 206 and not at the interface between the structure 201 and the layer 203. Thus, the diffusing region 202 is situated at least partially between the diffusing region 202 and the security element 204.

When the multilayer structure is observed from the side of the face 208, and illuminated from the side of the opposite face 206, as illustrated in FIG. 14A, by both visible light and an exciting light, the luminescent layer is excited. The colored light produced by excitation is sufficiently intense, after diffusing through the structure 201, to illuminate the security element, which appears to be illuminated by a colored light for the observer, as illustrated in FIG. 14B.

When the multilayer structure is observed in reflection, and illuminated via the face in visible and exciting light, the exciting light is scattered by the region 202 before reaching the luminescent layer 210. The latter is not, or is very weakly, excited, and the security element is not illuminated by a light that would be produced by the luminescent layer.

In variants, notably in FIGS. 11 and 13, the luminescent layer is at least partially coincident with the layer 203, the latter being for example a paper incorporating a fluorescent or phosphorescent agent within its bulk.

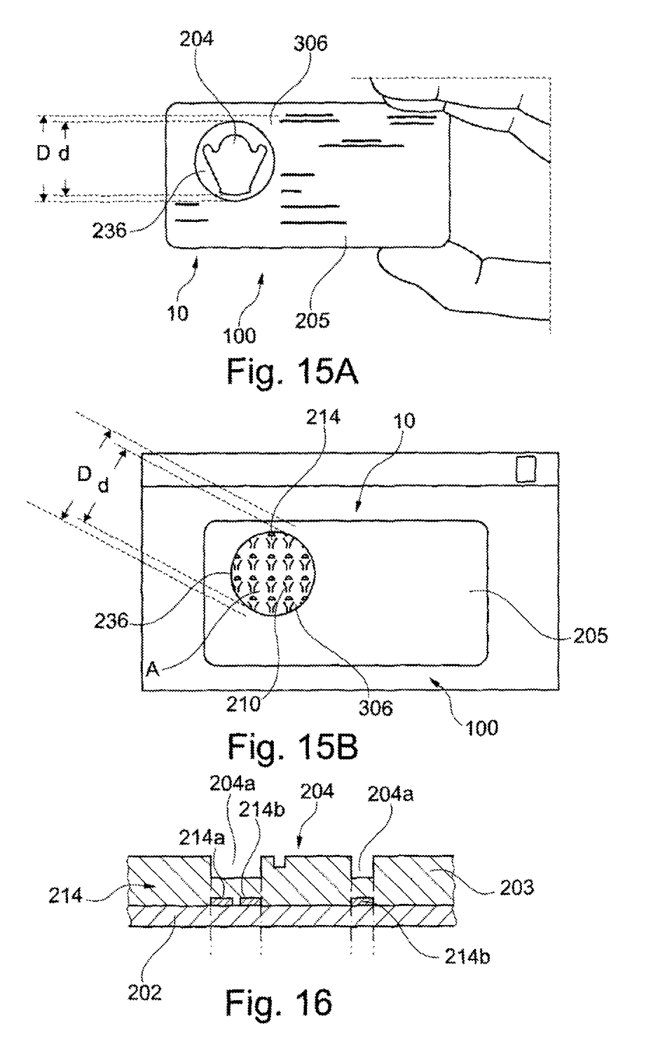

The security document 100, in the form of a card shown in FIGS. 15A and 15B, comprises a multilayer structure comprising at least the layers illustrated in FIG. 11.

In this variant, the structure 10 comprises a paper patch 236, corresponding to the layer 203, carrying the security element, for example a pattern of a watermark or pseudo-watermark 204. The paper patch 236 is coated on the back side of the watermark with a fluorescent layer 210 comprising a monochromatic or polychromatic print of a pattern reproducing the watermark design, in the example illustrated a reduced reproduction of red color under UV light. The structure 10 also comprises an opaque apertured layer 205. The patch 236 is disposed in an opening 306 of the apertured layer 205. The patch 236 formed from a disk of diameter D is for example, as previously explained, slightly larger than that of the circular opening 306 of diameter d.

FIGS. 15A and 15B show the card from the side of the watermark or pseudo-watermark 204. In FIG. 15A, the card is held in front of a source of visible light and the watermark 204 is observed under transmitted light.

In FIG. 15B, the document 100 is illuminated under UV light. Only a region of observation A, defined by the opening 306, is visible.

The exciting light is not scattered by the structure 201 and can excite the luminescent layer 210 which then emits a red light. The pattern 214 of the layer 210 becomes visible and exhibits an array of reproductions of the watermark design.

In the example, the pattern 214 of the first luminescent layer extends between the watermark or pseudo-watermark 204 and the diffusing region 202.

The pattern 214 may be disposed in alignment with the watermark or pseudo-watermark 204, in particular disposed so as to be located with respect to a clear region 204a of said watermark or pseudo-watermark as illustrated in FIG. 16. The regions 214a and 214b of the pattern 214 of the luminescent layer may emit a light of the same color. In one variant, the regions 214a and 214b correspond to different formulations in order to produce a polychromatic overall pattern.

This exemplary embodiment of a document combines a security element observable in visible light and a hidden image present in the fluorescent layer and observable when the document is subjected to a predefined type of exciting radiation. The two observations reveal two elements using the same pattern which facilitates the authentication by means of such a device. A method of authentication by such a device may comprise the following steps:
observe the structure from the side of the first security element, by illuminating in visible light,
observe, from the side of the first security element, the structure subjected to the exciting radiation,
generate information relating to the authenticity by comparing the aspects of the first security element and of the hidden image such as revealed by the exciting radiation.

The invention is not limited to the exemplary embodiments previously described, covering other forms of watermark, and other colors of the luminescent layers.

In particular, the diffusing structure, and notably the interposed sub-structure, may comprise a phosphorescent layer as a replacement for the fluorescent layer, or may comprise a fluorescent layer on the front side and a phosphorescent layer on the back side. The luminescent compounds may be so under IR illumination.

In some examples, the luminescent layers are superposed exactly. As a variant, one of the luminescent layers is wider than the other. Nevertheless, this does not allow two colors of luminescence to be observed from one face of the structure, because all the exciting radiation (UV or IR) is absorbed or scattered before reaching the second luminescent layer.

The fact that one of the luminescent layers is smaller than the other can allow a bounding of this layer with respect to the other to be seen because of the absorption. If the diffusing region has at least one opening, the two colors of luminescence could potentially be observed simultaneously, if one of the luminescent layers is wider than the other and if its light passes through said opening.

Watermark or Pseudo-Watermark/Fibrous Layer(s)

The multilayer structure according to the invention may comprise at least one fibrous layer which may carry a watermark or pseudo-watermark and, preferably, the structure comprises two fibrous layers each carrying a watermark or pseudo-watermark.

The fibrous layer may comprise one or more assembled fibrous jets, notably by lamination or by assembly in the wet part of the paper mold machine during the fabrication of said fibrous layer.

The watermarks are conventionally obtained during the wet-phase fabrication of a sheet of paper by the deposition of the paper pulp onto the embossed fabric of a cylinder paper mold machine, the quantity of pulp deposited being greater in the hollows and less on the bumps with respect to the rest of the paper.

The watermarks may also be formed by embossing of a wet sheet with a watermarker roll (also known as “dandy roll”) on a Fourdrinier paper mold machine.

It is furthermore known for pseudo-watermarks to be formed on a sheet of paper: the pseudo-watermarks reproduce the appearance of a watermark by exhibiting differences in opacity. These pseudo-watermarks may be obtained mechanically by applying pressure with or without heat and/or chemically by application of a compound, for example by locally increasing the transparency of the paper by means of suitable substances. The density of fibrous material between the lightest and darkest areas of the pseudo-watermark may be uniform as opposed to a conventional watermark.

The pseudo-watermark may be produced within the finished fibrous layer by mechanical and/or chemical means by application of certain products, the pattern always being visible in transparency.

The pseudo-watermark may for example be formed by depositing or by printing, in given areas of the fibrous layer, a compound which modifies the transparency of the fibrous layer, notably in order to form clear areas and dark areas, similar to those of a watermark, without however obtaining a result allowing details and variants in luminosity to be obtained that are comparable with those of a conventional watermark.

For example, the finished fibrous layer may be made to be transparent by for example applying, in given areas, a generally oily compound which renders the fibrous layer permanently transparent, such as for example a compound made from oil and from a transparent mineral material such as is described in the U.S. Pat. No. 2,021,141 or such as for example a compound taking the form of a wax combined with a solvent such as is described in the U.S. Pat. No. 1,479,337.

The finished fibrous layer may also be rendered transparent by locally applying a wax using hot transfer, such as is described in the U.S. Pat. No. 5,118,526.

A fibrous layer comprising a thermofusible material may furthermore be employed, for example polyethylene, such as is described in the patent EP 0 203 499, which, under the local action of the heat, will see its transparency vary.

The finished fibrous layer may be opacified, without however rendering it completely opaque, by applying an opacifying agent in given areas which increases the opacity of the fibrous layer, such as is for example described in the patent application FR 2 353 676.

The opacifying agent may for example be an aqueous suspension of a pigment or of a charge or a solution of a chemical compound, of a colored compound or of a tinting agent. This agent may be applied during the fabrication of the fibrous layer, onto the fibrous web, and before its removal from the fabric, in such a manner that the agent penetrates into the voids of the web and causes a modification of the opacity of the web to be treated in chosen areas, after drying. This fabrication technique has the drawback of requiring special roller devices for applying the agent, and of preferably employing an aspiration device in order to make the agent penetrate into the voids of the web.

A pseudo-watermark may furthermore be formed according to the method described in the document by W. WALENSKI, “Watermarks and Those that Are Not”, Druckspiegel 52, no 3: 66-68 (March 1997). This document describes a method for fabricating a pseudo-watermark on a non-coated paper, comprising the application under heat and pressure of a marking element, representing the pattern of the pseudo-watermark, onto a re-wetted paper sheet.

The international application WO 97/17493 also describes the fabrication of coated paper comprising pseudo-watermarks resulting from a variation in the layer weight applied in given areas, which leads to a variation in thickness and in opacity in the zones where the layer weight is reduced or increased.

The international application WO 1999/014433 also describes another method for fabricating a pseudo-watermark on a coated paper, which includes the formation of an image in the paper after the drying step which follows the last coating operation, by carrying out the steps in which a re-wetting solution is applied onto at least one face of the coated paper, in one or more given areas, and pressure and heat are applied in the area or areas of the re-wetted coated paper so as to evaporate the solution and to densify the coated paper in the area or areas with respect to the rest of the paper.

The pseudo-watermark may lastly be formed by mechanical means by creating marks by mechanical embossing of given areas of the fibrous layer such as described in the patent DE 3 718 452.

The watermark or pseudo-watermark of each fibrous layer may be visible, at least partially, only from the visible face of the fibrous layer comprising it, notably in the translucent region of the sub-structure.

The fibrous layer or layers may be formed on a Fourdrinier or cylinder paper mold machine, and the watermarks may be incorporated into the fibrous layer or layers in the wet part according to the conventional methods known to those skilled in the art.

The fibrous layer or layers may furthermore be formed on a Fourdrinier or cylinder paper mold machine, and the pseudo-watermarks may be formed on the finished layers by mechanical or chemical means according to the conventional methods known to those skilled in the art.

At least one fibrous layer may comprise printed features, notably for customization, formed, for example using offset printing, by rotogravure, serigraphy or flexography, by intaglio printing, by typography, by laser or inkjet. The printed features may for example correspond to fixed texts and/or to the variable texts of an identity document. The printed features may comprise a photograph, for example that of the holder of the document.

At least one fibrous layer may for example be based on paper of the LASERGUARD® or JETGUARD® type, marketed by the company ARJOWIGGINS.

At least one fibrous layer may be colored, fluorescent, iridescent or exhibit any other optical nuance or effect.

The fibrous layer may be luminescent, notably fluorescent, in which case the luminescent layer is the same as the fibrous layer. If the fibrous layer is luminescent, the effect is less visible than with an additional luminescent layer under the watermark, but this has the advantage of eliminating one step in the industrial process.

If the layer is colored, the color is preferably of reduced intensity so as not to lose the ‘Dual watermark’ effect and so as not to attenuate the effect known as ‘Dual fluo’ too much; if the layer is iridescent, there is a greater increase in the opacity.

At least one fibrous layer may contain cellulose fibers, for example cotton fibers, and/or synthetic fibers and/or natural organic fibers, other than cellulose-based, and/or mineral fibers.

At least one fibrous layer may have an areal density in the range between 60 and 220 g/m2, preferably between 50 and 120 g/m2.

At least one fibrous layer may have a thickness in the range between 60 and 220 μm, preferably between 70 and 110 μm, for example around 100 μm.

The first and second security elements, notably the first and second watermarks or pseudo-watermark, the first and second luminescent layers and the diffusing region of the diffusing structure may be at least partially superposed.

The first and second security elements may be exactly superposed.

Luminescent Layer

The first and/or the second luminescent layer may be an imprint. The imprint may reproduce a pattern of the security element, in particular of a watermark or pseudo-watermark. The first and/or the second luminescent layer may comprise a luminescent ink applied as a solid color.

In one variant, the first and/or the second luminescent layer is conFIG.d for producing a polychromatic light pattern, visible under exposure to the predefined type of exciting radiation. The predefined type of exciting radiation may correspond to an ultraviolet illumination, notably with a wavelength near to the visible, for example around 365 nm. As a variant, the predefined type of exciting radiation corresponds to an infrared illumination.

At least one of the first and second luminescent layers may be a fluorescent layer. The fluorescence will be seen by reflection or by transmission depending on the configurations. For example, the same color could be observable by reflection on the illuminated face and by transmission on the non-illuminated face by virtue of the diffusing structure which allows the exciting radiation to be scattered and avoids the luminescent layers being simultaneously excited. Preferably, there is no transmission of the UV or IR through the multilayer structure, at least in the area being superposed onto the diffusing region, which may extend to the whole extent of the multilayer structure.

In exemplary embodiments of the invention comprising two fibrous layers and two luminescent, notably fluorescent, layers disposed on either side of a diffusing structure, in the case of excitation from the face defined by the first fibrous layer of the multilayer structure, the first luminescent layer absorbs a large part of this radiation and emits visible radiation. This visible radiation is transmitted in part to the second fibrous layer, since a part is lost notably by scattering through the diffusing region; the remainder of the exciting radiation which has passed through the first luminescent layer is scattered in the diffusing structure and substantially no exciting radiation reaches the second luminescent layer, so that the observer does not see any emission of visible light by this second luminescent layer.

At least one of the first and second luminescent layers may be a phosphorescent layer. The first and second luminescent layers may be fluorescent, or respectively phosphorescent. One of the first and second luminescent layers may be phosphorescent and the other fluorescent.

Diffusing Structure

The diffusing structure, in the sense of the invention, is a structure which overall occupies a certain space within the thickness of the multilayer structure and which comprises a diffusing region, which may or may not extend over the whole extent of the diffusing structure. Thus, outside of the diffusing region, the diffusing structure may exhibit any given optical properties, notably non-diffusing; for example, it may be opaque or transparent. In exemplary embodiments of the invention, the diffusing region extends over the whole of the structure, which is then, for example, defined by a substrate with a uniform composition. Preferably, the diffusing structure is formed in such a manner as to exhibit the “Dual watermark” effect and the “Dual fluo” effect.

The diffusing structure, also referred to as interposed sub-structure when it is situated between two layers, notably external layers, of the multilayer structure, may thus comprise a translucent region or be translucent over its whole surface.

The diffusing structure may comprise a translucent region and/or light-scattering region or be translucent and/or scatter light over its whole surface.

The term “translucent” is taken to mean the fact that the region of the structure allows enough visible light to pass so as to see through the structure.

The term “diffusing” is taken to mean the fact that the diffusing structure, in its diffusing region, scatters the visible and exciting light, by virtue of its nature and of its thickness. In particular, the diffusing region is non-opaque, notably with respect to visible light.

Preferably, the intensity of the predefined type of exciting radiation is attenuated by at least 80% by scattering when it passes through the diffusing region.

The light-scattering nature of the diffusing region, notably of the substrate which defines it, may result from its index of refraction, from its composition, from its thickness and/or also from its surface irregularities.

More particularly, the light-scattering nature may be such that the multilayer structure exhibits the “Dual fluo” effect. For example, the index of refraction of the diffusing region may contribute to endowing properties for scattering light, in particular the predefined type of exciting radiation, to a sufficient extent for the multilayer structure to exhibit the “Dual fluo” effect. The diffusing structure may comprise mineral or organic charges, bubbles, or cavitations endowing it with a light-scattering nature.

The light-scattering nature may be linked to the employment of a particular substrate in order to form the diffusing structure or at least one of the layers of the latter.

According to a particular case, the surface irregularities of the diffusing region and more particularly of the substrate which defines it are obtained by embossing or graining of this surface.

According to another particular case, the substrate comprises cavitations, for example bubbles, endowing it with a light-scattering nature.

According to another particular case, the substrate comprises a diffusing charge chosen in particular from amongst mineral pigments, in particular kaolin or titanium dioxide, and organic pigments, in particular polystyrene or polyurethane beads.

The diffusing structure may have a thickness in the range between 10 and 1000 μm, preferably between 250 and 350 μm.

The diffusing region preferably has the same thickness as the rest of the diffusing structure.

The diffusing region may for example occupy more than 10%, better 50%, even better 90%, of the volume corresponding to the diffusing structure.

The diffusing structure may be a monolayer or a multilayer, and may comprise one or more fibrous and/or polymer layers.

The layers may be composed of identical or different materials, for example such as those mentioned hereinafter for the diffusing structure.

The diffusing structure, notably the interposed sub-structure, may comprise a fibrous layer, for example containing vegetable fibers, for example cellulose, in particular cotton fibers, and/or synthetic fibers such as for example fibers of polyamide and/or of polyester.

The fibrous layer may be a paper, for example a tracing paper.

The diffusing structure may comprise a layer of a thermoplastic material, for example polyethylene (PE), of polyvinyl chloride (PVC), polyethylene terephthalate (PET), polycarbonate (PC), polylactic acid (PLA), polyester carbonate (PEC), polyethylene terephthalate glycol (PETG) or acrylonitrile butadiene styrene (ABS), for example in the form of a film or of an extruded layer.

The diffusing structure may be composite and comprise at least one polymer layer and one fibrous layer, each layer being for example chosen from amongst the aforementioned materials.

The diffusing structure may have a configuration of the PAPERLAM® type marketed by the company AROWIGGINS, with at least one layer aimed at compensating for the thickness of an element integrated into the structure.

The diffusing structure, notably when it forms an interposed sub-structure, may comprise one or more layers assembled with the aid of one or more adhesive layers, for example such as defined hereinafter, or else alternatively without adhesive, by fusion or by soldering.

The diffusing structure may be a transparent plastic film covered with a material having a high scattering index, for example nanoparticles.

The thickness and the nature of the layers of the diffusing structure, notably the interposed sub-structure, are advantageously chosen in such a manner that the diffusing structure, in particular in the diffusing region, notably translucent, exhibits the desired properties of non-opacity and of diffusion, so as to obtain the “Dual watermark” effect, in other words to prevent a combination of the watermarks or pseudo-watermarks of the fibrous layers during an observation of the structure in transmitted white light.

The diffusing structure, and notably its diffusing region, may extend over the whole surface of the watermark(s) or pseudo-watermark(s).

The diffusing structure, notably the interposed sub-structure, may extend over a part of the multilayer structure within an area facing the watermark(s) or pseudo-watermark(s).

The diffusing structure, notably the interposed sub-structure, may only extend over a part of the surface of the watermark(s) or pseudo-watermark(s), a part of the watermark(s) or pseudo-watermark(s) thus only being visible from one face of the structure, whereas the part not covered by the interposed sub-structure is visible on either side of the structure in transmitted light.

Electronic Device

The multilayer structure according to the invention advantageously comprises at least one electronic device, preferably at least partially integrated into the diffusing structure, notably when the latter forms an interposed sub-structure. In this case notably, the interposed sub-structure is also referred to as an “inlay”.

The electronic device may be chosen from amongst integrated microcircuits using communications without or with contact or else having both communications possibilities, with and without contact, microcircuits with an antenna integrated on a chip, resonant microcircuits, microcircuits with electromagnetic wave communications, micro-transponders, photo-activatable micro-transponders, notably by laser beam, and micro-transponders reacting to a beam of light, for example of diffuse light.

The electronic device may or may not be programmable. The electronic device may be read-only or read/write.

The device may result from the association of a chip with at least one antenna, in the case of a system without contact.

Other Security Elements

The multilayer structure according to the invention may comprise one or more security elements, chosen from amongst the following, amongst others:
photochromic or thermochromic components, dyes and/or pigments, notably in printed form or mixed with at least one component layer of the structure,
a specific light-collecting material, for example of the “waveguide” type,
an interference multilayer film,
a structure with variable optical effects based on interference pigments or on liquid crystals,
a birefringent or polarizing layer,
a diffracting structure,
an embossed image,
means producing a “moiré effect”, such an effect being for example capable of making a pattern appear that is produced by the superposition of two security elements on the article, for example by overlay of lines of two security elements,
a partially-reflecting refractive element,
a transparent lensing array,
a lens, for example a magnifying glass,
a colored filter,
a security thread incorporated for example within the bulk of at least one component layer of the structure or in a window, potentially comprising an imprint printed as a positive or as a negative, a metallic, goniochromatic or holographic effect, with or without one or more de-metallized parts,
a metallized, goniochromatic or holographic foil,
a layer with a variable optical effect based on interference pigments or on liquid crystals,
a flat security element of relatively small format such as a strip, visible or invisible, with or without an electronic device,
particles or clusters of particles of pigments or colorants of the HI-LITE type, visible or invisible,
security fibers, notably metal, magnetic (using soft and/or hard magnetism), or diffusing, or excitable in light,
an automatically readable security system having specific characteristics of light absorption, of Raman activity, of magnetism, of microwave interaction, of interaction with X-rays or of electrical conductivity.

The expressions “comprising a” or “comprising one” should be understood to mean “comprising at least one”.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A multilayer structure comprising:
a first security element, notably a watermark or pseudo-watermark,
a diffusing structure, comprising a diffusing region being at least partially superposed onto the first security element,
a first luminescent layer being at least partially superposed onto the first security element and capable of emitting, when it is subjected to a predefined type of exciting radiation, visible light of a first color, the first luminescent layer extending at least partially between the first security element and said diffusing structure or the diffusing structure extending at least partially between the first security element and the first luminescent layer.

2. The structure as claimed in claim 1, the first security element being a watermark or pseudo-watermark.

3. The structure as claimed in claim 1, the first security element only being observable in transmitted light, through the structure, when it is subjected to the predefined type of exciting radiation and/or white light, from the face of the structure situated on the same side as this first security element.

4. The structure as claimed in claim 1, furthermore comprising:
a second security element, notably a watermark or pseudo-watermark, said diffusing region of the diffusing structure being at least partially superposed onto the second security element,
a second luminescent layer with a different composition from the first, capable of emitting, when it is subjected to the predefined type of exciting radiation, visible light of a second color, different from the first, the second luminescent layer being at least partially superposed onto the second security element, the diffusing structure being situated between the first and the second luminescent layer, the first and second luminescent layers being preferably situated between the first and second security elements.

5. The structure as claimed in claim 4, the second security element being a watermark or pseudo-watermark.

6. The structure as claimed in claim 4, the first and second security elements and the first and second luminescent layers being at least partially superposed.

7. The structure as claimed in claim 4, the first and second security elements being exactly superposed.

8. The structure as claimed in claim 4, the first and second security elements being watermarks.

9. The structure as claimed in claim 4, the first and second luminescent layers being exactly superposed.

10. The structure as claimed in claim 1, comprising an electronic device, preferably accommodated in the diffusing structure.

11. The structure as claimed in claim 3, each security element only being observable in transmitted light, through the structure, when it is subjected to the predefined type of exciting radiation and/or white light, from the face of the structure situated on the same side as this security element.

12. The structure as claimed in claim, 1 the predefined type of exciting radiation corresponding to an ultraviolet or infrared illumination, notably with a wavelength near to the visible.

13. The structure as claimed in claim 1, the first and/or the second luminescent layer being substantially colorless in white light.

14. The structure as claimed in claim, 1 the first and/or the second luminescent layer producing a mono- or polychromatic light pattern under exposure to the predefined type of exciting radiation.

15. The structure as claimed in claim 4, the first and/or the second luminescent layer being a fluorescent layer.

16. The structure as claimed in claim 4, the first and/or the second luminescent layer being a phosphorescent layer.

17. The structure as claimed in claim 15, the first and second luminescent layers being fluorescent.

18. The structure as claimed in claim 16, the first and second luminescent layers being phosphorescent.

19. The structure as claimed in claim 1, the diffusing structure having a thickness in the range between 10 and 1000 microns, or better between 250 and 350 microns, in the diffusing region.

20. The structure as claimed in claim, 1 the diffusing region attenuating the predefined exciting radiation, notably UV or IR.

21. The structure as claimed in claim 20, the diffusing region reducing by at least 80% the intensity of the exciting radiation when it passes through.

22. The structure as claimed in claim, 1 the first luminescent layer being distinct from a layer carrying the first security element, notably a fibrous layer, the security element then preferably being a watermark.

23. The structure as claimed in claim 1, the first luminescent layer being at least partially, or even entirely, coincident with a layer carrying the security element.

24. A security document incorporating a multilayer structure as claimed in claim 1.

25. The security document as claimed in claim 24, said document comprising a booklet and/or the security document constituting at least a part of an identity document, notably an identity card or a passport, a means of payment, notably a bank note, a coupon, a cheque, a voucher, a credit card, a ticket for access to cultural or sports events, or a certificate of authenticity.

26. A method for authenticating a document incorporating a multilayer structure as claimed in claim 4, comprising the following steps:
a) observation by reflection of at least one of the first and second security elements, by illuminating the structure with a light corresponding to the predefined type of exciting radiation,
b) observation under this illumination, by transmission, of at least one of the first and second security elements,
information relating to the authenticity being determined at least as a function of the comparison of the observations a) and b).

27. The method for authenticating a document incorporating a multilayer structure as claimed in claim 16, comprising the following steps:
illuminate the phosphorescent layer of the structure with a light capable of exciting the phosphorescence of said layer and observe the first security element, with the color of luminescence of the phosphorescent layer,
stop the illumination and turn the structure over or vice versa, and observe the second security element, with the color of luminescence of the phosphorescent layer.

28. The method for authenticating a document incorporating a multilayer structure as claimed in claim 17 comprising the following steps:
observe at least one of the security elements, on one of the faces of the structure,
illuminate successively each of the faces of the structure with the predefined light for excitation of the fluorescence of the first and second layers,
observe the change in color of illumination by luminescence of said security elements.

29. The method for authenticating a document incorporating a multilayer structure as claimed in claim 17 comprising the following steps:
illuminate one of the faces of the structure with a light for exciting the fluorescence of the first and second luminescent layers,
turn the structure over and observe the change in color of luminescence of the security elements.

30. A method for authenticating a multilayer structure as claimed in claim 1, comprising the following steps:
observe the structure in transmission by illuminating from the side opposite to the first security element with the exciting radiation and visible light and by observing from the side of the first security element,
observe the structure in reflection by illuminating from the same side as the first security element with the exciting radiation and visible light and by observing from the side of the first security element,
generate information relating to the authenticity by comparing the aspects of the first security element under the various conditions of observation hereinabove.
